(19) United States
(12) Patent Application Publication
(10) Pub. No.: US 2012/0208521 A1
(43) Pub. Date: Aug. 16, 2012

(54) Antenna Mast and a Method of Providing a Further Function in an Antenna Mast

(76) Inventors: Peter Häger, Djursholm (SE); Anders Röhl, Enskede (SE)

(21) Appl. No.: 13/025,565

(22) Filed: Feb. 11, 2011

(51) Int. Cl. H04W 4/20; H01Q 1/12; H01Q 1/00

(52) U.S. Cl. 455/422.1; 343/720; 343/721; 343/890

(57) ABSTRACT

An antenna mast for a wireless communication system is provided. The antenna mast comprises a mast body that is configured to form a supporting structure for an antenna arrangement of the wireless communication system at an elevated position on the antenna mast. The mast body is also configured to house therein a transceiver arrangement and a processor adapted to perform random user-related communication operations in a cell of the wireless communication system, the cell comprising the antenna arrangement, the transceiver arrangement, and the processor. The mast body is further configured to house at least part of a device to be utilized for a function other than supporting the antenna arrangement. The device comprises a communication interface for establishing a connection with the wireless communication system. A method of providing a further function in an antenna mast for a wireless communication system is also provided.

### TECHNICAL FIELD

The technical field concerned relates to an antenna mast for a wireless communication system according to the pre-characterizing portion of claim 1, as well as a method of providing a further function in an antenna mast for a wireless communication system.

### BACKGROUND

Wireless communication systems using radio communication comprise transceiver arrangements and processors comprised in what may be referred to as base stations, radio network controllers, or node Bs. Furthermore, antennas are connected to the transceiver arrangements and are required for transmitting and receiving radio signals. The antennas may for instance be arranged on an antenna mast. A variety of masts have been suggested in the prior art but in practice a steel lattice mast is the most common type of mast used.

Wireless communication such as mobile internet access is demanded by an increased number of people and provided in more devices. Thus, radio traffic within the wireless communication systems increases and so does the required number of access points for the mobile communication equipment. For each access point at least one antenna is required and thus the number of antennas that are required increases with the increased demand in mobile internet access. The provision of a further function other than supporting an antenna arrangement has been suggested.

EP1198024 discloses an antenna mast wherein an antenna is raised and lowered along a guiding means inside the antenna mast. According to one embodiment, the antenna mast comprises a carrying pipe for a lamp.

WO98/58420 discloses a wireless communication pole system. The system is fully integrated for rapid installation. The system comprises a pole, a base assembly, and an antenna assembly. According to one embodiment the pole doubles as a banner-carrying light pole.

EP1286412 discloses a radio tower with a central supporting tower structure comprising several modules of the same outer shape being arranged one above the other. The modules house for instance transmission and power supply equipment. Further, the tower comprises stiff ring-shaped portions of covering made from glass fibre reinforced plastic material, inside which the modules of the radio tower are arranged. Each ring-shaped covering is supported by a module of the radio tower. On the outside of the covering, screens for providing information or announcements may be arranged. Also the use of the covering for housing small shops or ticket machines is suggested.

A high number of access points, and accordingly antennas, for wireless communication systems places a requirement on associated antenna masts to be accepted by the public. There exists a need to provide increased functionality in connection with antenna masts provided with a device to be utilized for a further function other than supporting an antenna arrangement.

### SUMMARY

An object is thus to meet at least one of the above mentioned requirements or needs.

According to an aspect, the object is achieved by an antenna mast for a wireless communication system in a communication network. The antenna mast comprises a mast body forming a supporting structure for an antenna arrangement of the communication system at an elevated position on the antenna mast. The antenna mast is arranged to include a device to be utilized for a further function other than carrying the antenna arrangement. The mast body houses therein a transceiver arrangement and a processor adapted to perform user-related communication operations in a cell of the wireless communication system. The antenna arrangement, the transceiver arrangement, and the processor define the cell. The mast body further houses at least part of the device to be utilized for the further function. The device to be utilized for the further function comprises a communication interface for establishing a connection with the wireless communication system.

Since the device to be utilized for the further function comprises a communication interface for establishing a connection with the wireless communication system, the device may be put to more reliable, more efficient, more qualified, and/or more advanced use. As a result, the above mentioned object is achieved. Thus the public may benefit from the device and the further function to a greater extent than if the device lacked the contemplated communication interface. Advantageously, the enhanced functionality of the device may result in more ready acceptance of the antenna mast by the public.

Different technologies may be used in wireless communication networks, such as Long Term Evolution (LTE), LTE-Advanced, 3rd Generation Partnership Project (3GPP) Wideband Code Division Multiple Access (WCDMA), Global System for Mobile Communications/Enhanced Data rate for GSM Evolution (GSM/EDGE), Worldwide Interoperability for Microwave Access (WiMax), or Ultra Mobile Broadband (UMB), just to mention a few possible implementations. A communication network may comprise transceiver arrangements and processors providing radio coverage over at least one respective geographical area forming a cell. User equipment, such as mobile telephones, are served in the cells by the respective transceiver arrangements and processors and communicate with the respective transceiver arrangements and processors. An antenna mast may be erected at an antenna site in a cell. Typically, such antenna sites are outdoors in areas frequented by the public. In such areas, use of wireless communication systems is to be expected. The communication network may also comprise parts which are not wireless.

According to embodiments the communication interface may be arranged to establish a connection with the cell of the wireless communication system. Such a connection may easily be accomplished due to the device to be utilized for the further function being arranged directly in the relevant antenna mast. Such a connection may be established via a wire or wirelessly. The connection with the cell may be established from the communication interface of the device to be utilized for the further function to the processor and/or the transceiver arrangement of the cell. The connection may be provided to a further communication interface which may be provided for the transceiver arrangement and/or the processor.

According to embodiments the device to be utilized for the further function may be adapted for transfer of data between the device to be utilized for the further function and a third apparatus via the wireless communication system. In this manner the device to be utilized for the further function and the third apparatus may communicate, which makes possible numerous ways of utilizing the device to be utilized for the further function. For instance, a user of the third apparatus may submit an inquiry as to a status of a device to be utilized for a further function, or a status of a service provided by the device. In another example the device to be utilized for the further function may report a status to the third apparatus.

According to embodiments the device to be utilized for the further function may be adapted to transmit data via the wireless communication system. Thus, the device to be utilized for the further function may send data from the antenna mast.

According to embodiments the device to be utilized for the further function comprises an input device and is adapted to receive input signals via the input device. In this manner the device to be utilized for the further function may be interactive. A user, or a further device, may input data or information to the device to be utilized for the further function. All input data, or part thereof, may be transferred via the wireless communication system to the third apparatus.

According to embodiments the input device may be a touch screen. Other examples of input devices may be a keypad, a card-reading device, or a short range radio communication device receiving signals form a transmitter of e.g. a mobile communication device such as a mobile telephone.

According to embodiments the device to be utilized for the further function may be adapted to receive data via the wireless communication system. Thus, the device to be utilized for the further function in the antenna mast may receive data.

According to embodiments the device to be utilized for the further function may comprise a clock, which may be adapted to receive control data via the wireless communication system and the communication interface. In this manner the clock may be set from a remote location.

According to embodiments the device to be utilized for the further function may comprise a traffic light, which may be adapted to receive control data via the wireless communication system and the communication interface. In this manner the traffic light may be synchronized with other traffic lights from a remote location.

According to embodiments the device to be utilized for the further function may comprise a compartment with a door and a lock for locking the door, the lock optionally being adapted to receive control data via the wireless communication system and the communication interface. In this manner the door may be unlocked from a remote location.

According to embodiments the device to be utilized for the further function may comprise a life-saving device such as a defibrillator, which life-saving device may be adapted to receive control data via the wireless communication system and the communication interface. In this manner the life-saving device may be activated from a remote location.

According to embodiments the device to be utilized for the further function may comprise a waste bin, which may be adapted to communicate a status of filling of the waste bin via the communication interface and the wireless communication system. In this manner service personnel may be informed of the status, and the waste bin may be emptied when required.

According to embodiments the device to be utilized for the further function may comprise a weather station, which may be adapted to send weather-related data via the communication interface and the wireless communication system. In this manner a weather station may be arranged at an antenna site and may report to a remote location via the wireless communication system.

According to embodiments the device to be utilized for the further function may comprise a monitoring arrangement, which may be adapted to send monitoring data via the communication interface and the wireless communication system. In this manner for instance pictures form a surveillance camera may be sent to a remote location via the wireless communication system.

According to embodiments the device to be utilized for the further function may comprise a vending machine, which may be adapted to communicate a status of the vending machine via the communication interface and the wireless communication system. In this manner service visits to the vending machine may be made when the communicated status so requires.

According to embodiments the device to be utilized for the further function may comprise an electronic screen, which may be adapted to receive data comprising information to be presented on the screen via the wireless communication system and the communication interface. In this manner the screen may be updated from a remote location to present current information at the site of the relevant antenna mast.

According to embodiments the device to be utilized for the further function may comprise a parking meter, which may be adapted to communicate data relating to the parking meter and/or car parking facilities via the communication interface and the wireless communication system. In this manner service personnel may be informed about service requirements of the parking meter and/or a vehicle driver who potentially would like to park his vehicle may be informed about the availability of parking spaces.

According to embodiments the device to be utilized for the further function may comprise an electric power socket, which may be adapted to communicate data relating to its use via the communication interface and the wireless communication system. In this manner a potential user of the power socket, such as a driver of an electric vehicle, may be informed about the availability of the power socket.

According to a further aspect, the object is achieved by a method of providing a further function in an antenna mast for a wireless communication system comprised in a communication network. The antenna mast comprises a mast body forming a supporting structure for an antenna arrangement of the wireless communication system at an elevated position on the antenna mast. The mast body houses a transceiver arrangement and a processor of the wireless communication system, and at least part of a device to be utilized for a further function. The method comprises:
performing user-related communication operations in a cell of the wireless communication system, the cell comprising the antenna arrangement, the transceiver arrangement, and the processor,
establishing a communication link between the device to be utilized for the further function and a third apparatus via the communication network, and
transferring data between the device to be utilized for the further function and the third apparatus via the communication link.

Since a communication link is established between device to be utilized for the further function and a third device via the communication network, possibilities of interaction with the device to be utilized for the further function are opened up. New ways of utilizing the device to be utilized for the further function are made possible. As a result, the above mentioned object is achieved. The public may accordingly more readily accept the presence of an antenna mast. Examples of utilizing the device to be utilized for the further function may include a user of the third apparatus submitting an inquiry as to a status of the device to be utilized for the further function or a status of a service provided by the device to be utilized for the further function. The device to be utilized for the further function may report a status to the third apparatus. The third apparatus may send control data to the device to be utilized for the further function to control aspects of the device to be utilized for the further function.

According to embodiments, establishing a communication link may comprise:
establishing a connection between the device to be utilized for the further function and the transceiver arrangement and/or the processor, and
establishing a connection between the transceiver arrangement and the third apparatus.

According to embodiments the connection between the device to be utilized for the further function and the transceiver arrangement and/or the processor may be established via a cable connection.

According to embodiments the connection between the device to be utilized for the further function and the transceiver arrangement and/or the processor may be established via a wireless connection.

According to embodiments, transferring data may comprise:
transferring data relating to a status of the device to be utilized for the further function and/or of a status of a service provided in connection with the device to be utilized for the further function. In this manner for instance users, potential users, and/or service personnel may be informed of the status of the device to be utilized for the further function, and/or of the status of a service provided by the device, and take action accordingly.

According to embodiments the device to be utilized for the further function may comprise an input device, and transferring data may comprise:
transferring data related to input signals received from the input device. In this manner a user of the device to be utilized for the further function may perform interactive steps in relation to the device to be utilized for the further function, such as performing payment of a specific amount of money from a credit card or a mobile communication device such as a mobile telephone, or inquiring as to traffic schedules of public transportation.

According to embodiments the device to be utilized for the further function may comprise an electronic screen, and transferring data may comprise:
transferring data comprising information to be presented on the electronic screen. In this manner information to be displayed on the electronic screen may be transferred from the third apparatus to the electronic screen.

According to embodiments the third apparatus may be a mobile communication device.

Further features and advantages will become apparent when studying the appended claims and the following detailed description. Those skilled in the art will realize that different features may be combined to create embodiments other than those described in the following, without departing from the scope as defined by the appended claims.

### BRIEF DESCRIPTION OF THE DRAWINGS

Various aspects of embodiments, including their particular features and advantages, will be readily understood from the following detailed description and the accompanying drawings, in which:

FIG. 1 illustrates an antenna mast for a wireless communication system according to embodiments,

FIG. 2 illustrates embodiments of communication equipment of a wireless communication system and a device to be utilized for a further function other than supporting an antenna arrangement of an antenna mast,

FIGS. 3a-3j illustrate embodiments of various devices to be utilized for a further function other than supporting an antenna arrangement of an antenna mast of a wireless communication system comprised in a communication network, and

FIG. 4 illustrates a method of providing a further function in an antenna mast for a wireless communication system comprised in a communication network.

### DETAILED DESCRIPTION

Reference is made to the accompanying drawings in which example embodiments are shown. Embodiments set forth herein should not be construed as limiting. Disclosed features of example embodiments may be combined as readily understood by one of ordinary skill in the art. Like numbers refer to like elements throughout.

Well-known functions or constructions will not necessarily be described in detail for brevity and/or clarity.

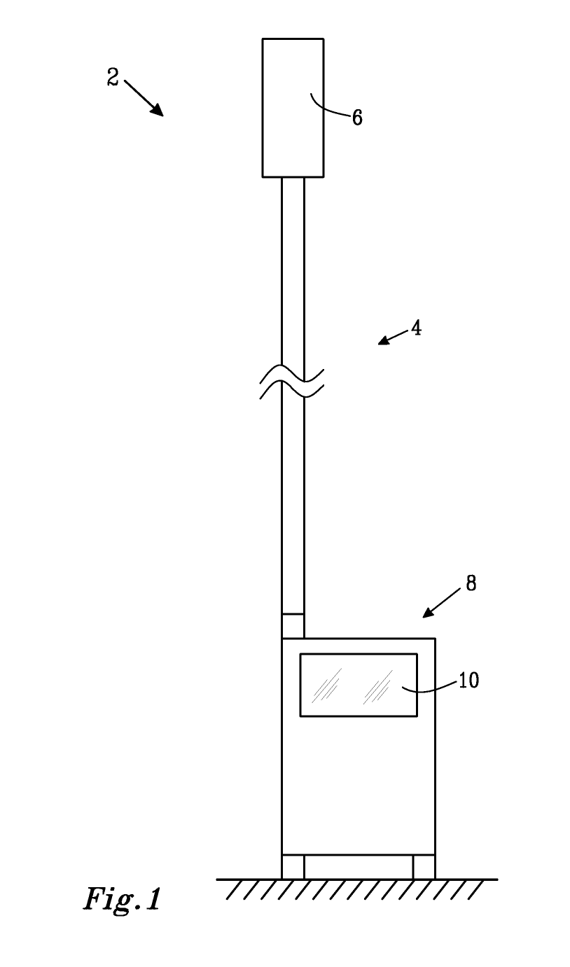

FIG. 1 illustrates an antenna mast 2 for a wireless communication system according to embodiments. The wireless communication system uses a communication standard, such as for instance GSM, WCDMA or LTE, and is comprised in a communication network. The antenna mast 2 comprises a mast body 4 forming a supporting structure for an antenna arrangement 6 of the communication system at an upper end of the antenna mast 2. The antenna arrangement 6 comprises a screen of a material permeable to radio waves arranged around one or more antennas of the antenna arrangement 6. The mast body 4 houses therein a transceiver arrangement and a processor adapted to perform random user-related communication operations in a cell of the wireless communication system, such as a person communicating via a mobile telephone with another person or a wireless device which via a web browser accesses a website stored on a remote server. The cell comprises the antenna arrangement 6, the transceiver arrangement, and the processor. The mast body 4 houses a device 8 to be utilized for a further function other than carrying the antenna arrangement 6. The device 8 to be utilized for the further function comprises an electronic screen 10.

The device 8 to be utilized for the further function comprises a communication interface for establishing a connection with the wireless communication system, i.e. the electronic screen 10 may communicate via the wireless communication system, for instance to receive information to be presented on the screen 10 from a third apparatus connected to the communication network at a remote location.

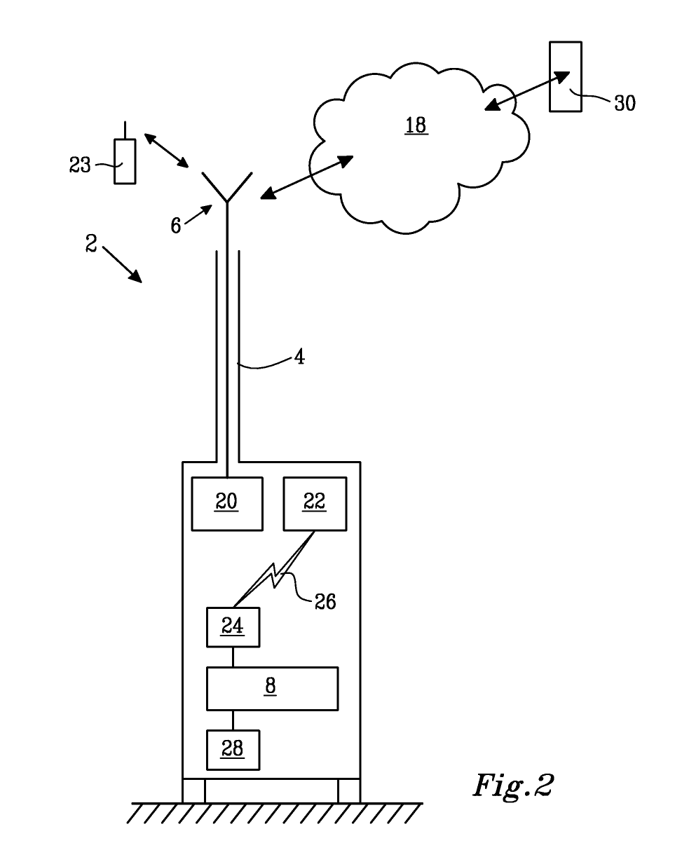

FIG. 2 illustrates embodiments of communication equipment of a wireless communication system and a device 8 to be utilized for a further function other than supporting an antenna arrangement 6 of an antenna mast 2. The wireless communication system is comprised in a communication network 18. The communication equipment comprises a transceiver arrangement 20 and a processor 22, both of which may be arranged inside a schematically illustrated mast body 4 of the antenna mast 2. Also, the device 8 to be utilized for the further function may be at least partially arranged in the mast body 4. The communication equipment comprises the antenna arrangement 6 which is connected to the transceiver arrangement 20. The transceiver arrangement 20 may comprise a combined transmitter and receiver, or separate transmitter and receiver units. In addition, the transceiver arrangement and the processor may form one unit. The antenna arrangement 6, the transceiver arrangement 20 and the processor 22 are adapted to perform random user-related communication operations in the relevant cell of the wireless communication system, as illustrated by a mobile telephone 23 of a random user communicating via the antenna arrangement 6, the arrangement 20 and the processor 22.

The device 8 to be utilized for the further function comprises a communication interface 24. A connection 26 is established between the communication interface 24 and the wireless communication system. The connection 26 is established with the processor 22 and/or the transceiver arrangement 20 of the communication equipment. The connection 26 may be established via wire or wirelessly. The device 8 to be utilized for the further function comprises an input device 28, via which a user may provide input to the device 8 to be utilized for the further function. A third apparatus 30 is connected to the communication network 18.

The device 8 to be utilized for the further function is adapted for transfer of data between the device 8 and the third apparatus 30 via the wireless communication system thanks to the provision of the communication interface 24. The data need not be transferred via the wireless communication system only, but may also be transferred via other parts of the communication network 18. Accordingly, a communication link between the device 8 to be utilized for the further function and the third apparatus 30 is established via the communication network 18. The data is transferred between the device 8 to be utilized for the further function and the third apparatus 30 via the communication link.

Data may be transferred only from the device 8 to be utilized for the further function to the third apparatus 30, data may be transferred only from the third apparatus 30 to the device 8 to be utilized for the further function, or data may be transferred in both directions between the device 8 to be utilized for the further function and the third apparatus 30.Depending on the type of device 8 to be utilized for the further function, different types of third apparatuses 30 may be relevant for the transfer of data. The third apparatus 30 may be e.g. a mobile communication device, such as a mobile telephone or a laptop computer, or a stationary server.

If, for instance, members of the public are allowed access to the device 8 to be utilized for the further function, for example when the device 8 is a parking meter, a charging arrangement for an electric vehicle, or an information screen, the data transferred may be a status of the device 8 and/or a status of a service provided in connection with the device 8. The status may be transferred to the mobile communication device and may include the availability of parking spaces, the availability of a power socket, or information relating to public transportation. Other types of data may be transferred from the device 8 to be utilized for the further function. For instance a device 8 in the form of a vending machine or in the form of a waste bin may transfer a status of filling to a remote server of a service organisation for the relevant device 8. The relevant service organisation in question may thus refill the vending machine and empty the waste bin when required. An example of data transfer from the third apparatus 30 to the device 8 to be utilized for the further function may be when software of the device 8 is to be updated or when data to be presented on a screen of the device 8 is to be changed.

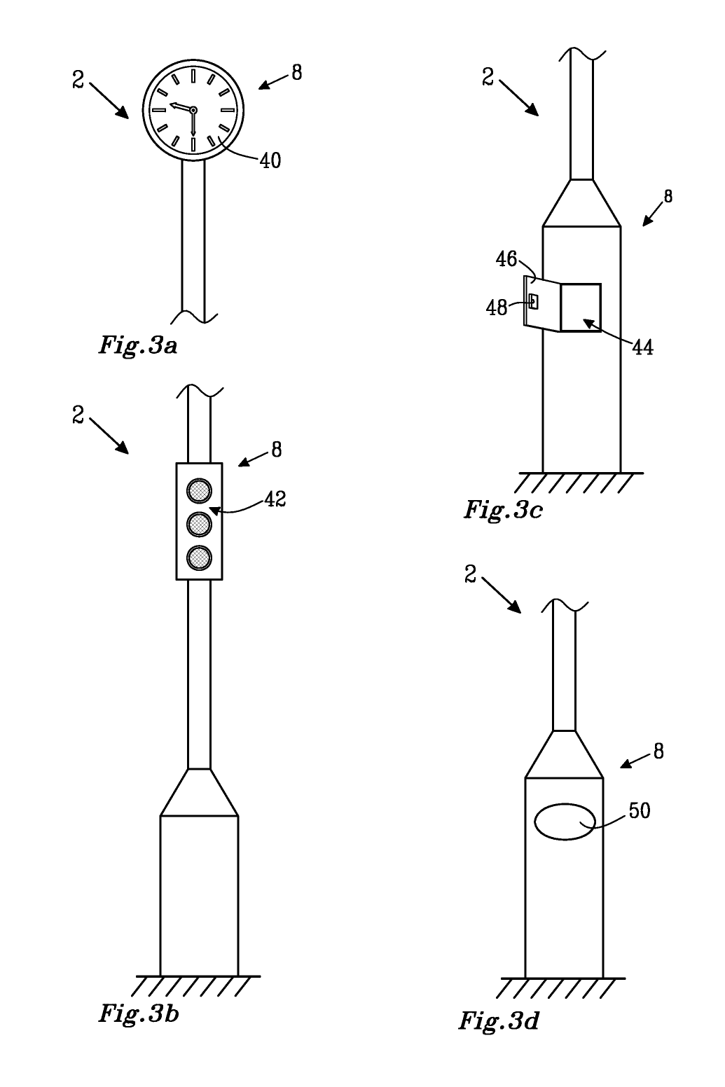

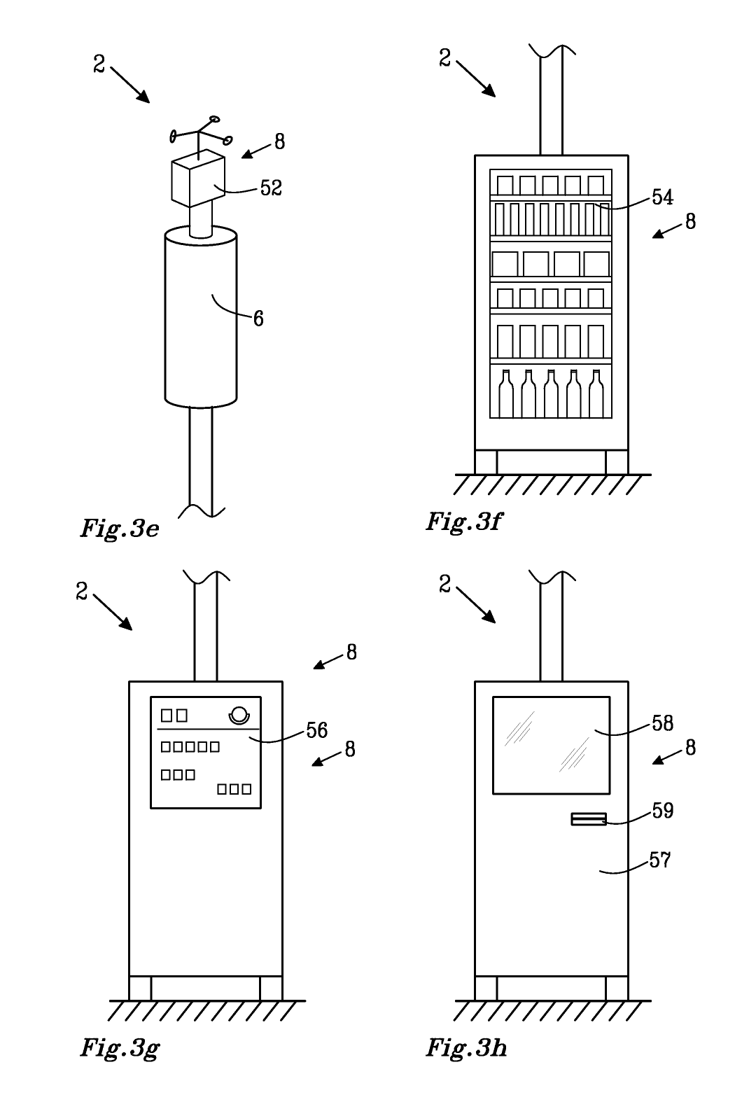

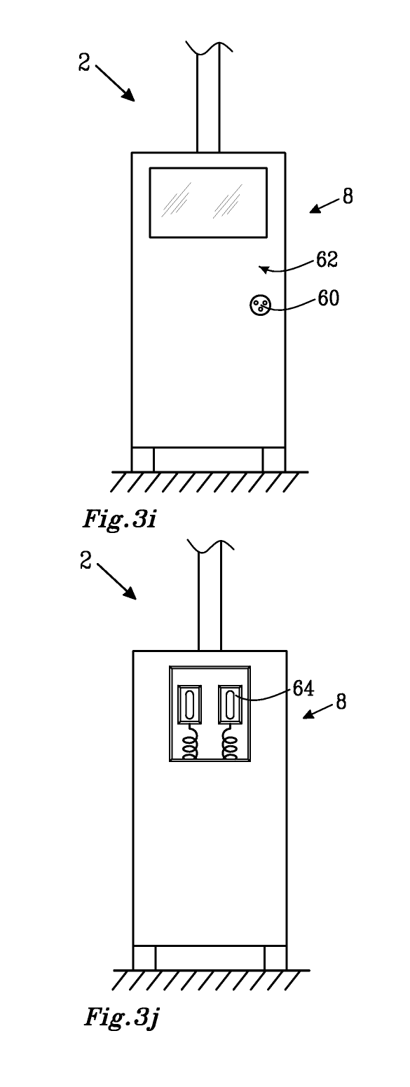

FIGS. 3a-3j illustrate embodiments of various devices 8 to be utilized for a further function other than supporting an antenna arrangement of an antenna mast 2 of a wireless communication system comprised in a communication network. Each device 8 comprises a communication interface and is adapted for at least one aspect of transfer of data discussed above. Accordingly, a connection may be established between the communication interface and the wireless communication system, and a communication link between the device to be utilized for the further function and a third apparatus may be established via the communication network. The antenna arrangement is supported at an elevated position by the antenna mast and may be a separate arrangement or may be integrated with the device 8 to be utilized for the further function.

FIG. 3a illustrates a portion of an antenna mast 2 comprising a device 8 to be utilized for a further function comprising a clock 40. The clock 40 is adapted to receive control data via the wireless communication system. In this manner the clock 40 may be set from a third apparatus connected to the communication network.

FIG. 3b illustrates a portion of an antenna mast 2 comprising a device 8 to be utilized for a further function comprising a traffic light 42. The traffic light 42 is adapted to receive control data via the wireless communication system. The traffic light may be controlled to be synchronized with other traffic lights from a third apparatus connected to the communication network and arranged at a traffic control station. Synchronization of the traffic light may be performed for instance, when emergency vehicles need a green light path, or to control different traffic situations at different times of the day.

FIG. 3c illustrates a portion of an antenna mast 2 comprising a device 8 to be utilized for a further function comprising a compartment 44 with a door 46 and a lock 48 for locking the door 46. The lock 48 is adapted to receive control data via the wireless communication system. Thus, a third apparatus connected to the communication network may lock or unlock the lock 48. In this manner equipment inside the compartment may be accessed by authorized persons, e.g. via sending data from a mobile telephone, which data unlocks the lock 48. Equipment inside the compartment may be rescue equipment such as a defibrillator, an oxygen container and mask, or a water hose.

FIG. 3d illustrates a portion of an antenna mast 2 comprising a device 8 to be utilized for a further function comprising a waste bin 50. The waste bin 50 is adapted to communicate a status of filling of the waste bin 50 to a third apparatus connected to the communication network. The third apparatus may be a data logger accessed by service personnel to schedule emptying of the waste bin 50.

FIG. 3e illustrates a portion of an antenna mast 2 comprising a device 8 to be utilized for a further function comprising a weather station 52. At least part of the weather station 52 is arranged above an antenna arrangement 6 supported by the antenna mast 2. The weather station 52 is adapted to send weather-related data to a third apparatus connected to the communication network. The third apparatus may be a data logger of a meteorological service provider.

FIG. 3f illustrates a portion of an antenna mast 2 comprising a device 8 to be utilized for a further function comprising a vending machine 54. The vending machine 54 is adapted to communicate a status of the vending machine 54 via the wireless communication system and the communication network to a third apparatus. The third apparatus may be a server of a service organization which is responsible for replenishing the vending machine.

FIG. 3g illustrates a portion of an antenna mast 2 comprising a device 8 to be utilized for a further function comprising an electronic screen 56. The electronic screen 56 is adapted to receive data comprising information to be presented on the screen 56 from a third apparatus connected to the communication network. The third apparatus may be a computer comprising current traffic information of a public transportation service. Traffic information presented on the screen 56 may thus be regularly updated.

FIG. 3h illustrates a portion of an antenna mast 2 comprising a device 8 to be utilized for a further function comprising a parking meter 57. The parking meter 57 comprises a touch screen 58 and a card-reading device 59. The parking meter 57 is adapted to communicate data relating to the parking meter and/or car parking facilities via the wireless communication system to a third apparatus connected to the communication network. The third apparatus may be a mobile communication device such as a mobile telephone or a personal digital assistant of a user. The user sends data to the parking meter from the third apparatus, e.g. to inquire as to availability of parking spaces, to inquire as to parking rates, or to reserve a parking space. In response, the parking meter may send the number of available parking spaces, the parking fee, or a confirmation of a reserved parking space. An owner of the parking meter 57 and a relevant car parking facility may send data from a third apparatus in the form of a computer connected to the communication network to the parking meter 57 to update parking fees or to change information provided on the touch screen 58 of the parking meter 57. The parking meter 57 may send data relating to a credit card inserted into the card-reading device 59 to a third apparatus in the form of a server of a bank service provider connected to the communication network.

FIG. 3i illustrates a portion of an antenna mast 2 comprising a device 8 to be utilized for a further function comprising an electric power socket 60. The device 8 to be utilized for the further function comprises a charging arrangement 62 for charging electric vehicles. The charging arrangement 62 is adapted to communicate data relating to its use via the wireless communication system and the communication network to a third apparatus. The third apparatus may be a mobile telephone of a user inquiring as to the availability of the charging arrangement 62 and the power socket 60.

FIG. 3j illustrates a portion of an antenna mast 2 comprising a device 8 to be utilized for a further function comprising a life-saving device such as defibrillator 64. The life-saving device is adapted to receive control data from a third apparatus via the wireless communication system, for instance software of the life-saving device may be updated from the third apparatus.

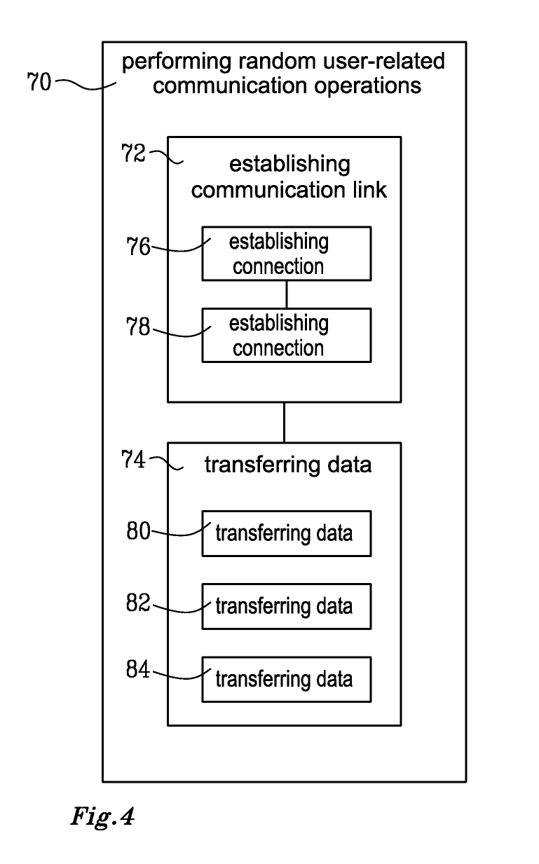

FIG. 4 illustrates a method of providing a further function in an antenna mast for a wireless communication system comprised in a communication network. The antenna mast comprises a mast body forming a supporting structure for an antenna arrangement of the wireless communication system at an elevated position on the antenna mast. The mast body houses a transceiver arrangement and a processor of the wireless communication system, and at least part of a device to be utilized for a further function other than supporting the antenna arrangement. The method comprises:
performing 70 random user-related communication operations in a cell of the wireless communication system, the cell comprising the antenna arrangement, the transceiver arrangement, and the processor,
establishing 72 a communication link between the device to be utilized for the further function and a third apparatus via the communication network, and
transferring 74 data between the device to be utilized for the further function and the third apparatus via the communication link.
   Performing 70 random user-related communication operations in the cell is performed independently of the established communication link between the device to be utilized for the further function and the third apparatus.

Establishing 72 a communication link may comprise:
establishing 76 a connection between the device to be utilized for the further function and the transceiver arrangement and/or the processor, and
establishing 78 a connection between the transceiver arrangement and the third apparatus.

The connection between the device to be utilized for the further function and the transceiver arrangement and/or the processor may be established 76 via a cable connection. Alternatively, the connection between the device to be utilized for the further function and the transceiver arrangement and/or the processor may be established 76 via a wireless connection.

The transferring 74 data may comprise:
transferring 80 data relating to a status of the device to be utilized for the further function and/or of a status of a service provided in connection with the device to be utilized for the further function.

The device to be utilized for the further function may comprise an input device, and transferring 74 data may comprise:
transferring 82 data related to input signals received from the input device.

The device to be utilized for the further function may comprise an electronic screen, and transferring 74 data comprises:
transferring 84 data comprising information to be presented on the electronic screen.

The third apparatus may be a mobile communication device, such e.g. a mobile telephone or a lap top computer.

Example embodiments described above may be combined as understood by a person skilled in the art. It is also understood by those skilled in the art that more than one device to be utilized for the further function may be arranged in one antenna mast. Method steps may be performed in a different order than illustrated in FIG. 4. The antenna arrangement may have one or more antennas exposed such that the one or more antennas are visible from the outside the antenna mast. Other means than a card-reading device may be arranged in an antenna mast for receiving payment from a user. For instance, payments may be performed via a mobile communication device such as a mobile telephone of a user, in which case the mobile communication device may communicate with the device to be utilized for the further function via short range radio communication or via the wireless communication system. An antenna mast may have a height of 3-8 metres. Antenna masts may also have a higher height such as up to 15 metres.

Although example embodiments have been described, many different alterations, modifications and the like will become apparent for those skilled in the art.

Therefore, it is to be understood that the foregoing is illustrative of various example embodiments and that modifications to the disclosed embodiments, combinations of features of disclosed embodiments as well as other embodiments are intended to be included within the scope of the appended claims.

As used herein, the term “comprising” or “comprises” is open-ended, and includes one or more stated features, elements, steps, components or functions but does not preclude the presence or addition of one or more other features, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

1. An antenna mast for a wireless communication system, the antenna mast comprising a mast body configured to:
form a supporting structure for an antenna arrangement of the wireless communication system at an elevated position on the antenna mast,
house therein a transceiver arrangement and a processor, the transceiver arrangement and processor configured to perform user-related communication operations for a cell of the wireless communication system, and
house therein at least part of a device configured to perform a function other than physically or functionally supporting the antenna arrangement, said device comprising a communication interface for establishing a connection with the wireless communication system.

2. The antenna mast according to claim 1, wherein the communication interface is configured to establish a connection with the cell of the wireless communication system.

3. The antenna mast according to claim 1, wherein the device is configured for transfer of data to and from a third apparatus via the wireless communication system.

4. The antenna mast according to claim 1, wherein the device is configured to transmit data via the wireless communication system.

5. The antenna mast according to claim 1, wherein the device comprises an input device and is adapted to receive input signals via the input device.

6. The antenna mast according to claim 5, wherein the input device is a touch screen.

7. The antenna mast according to claim 1, wherein the device is configured to receive data via the wireless communication system.

8. The antenna mast according to claim 1, wherein the device comprises a clock configured to receive control data via the wireless communication system and the communication interface.

9. The antenna mast according to claim 1, wherein the device comprises a traffic light configured to receive control data via the wireless communication system and the communication interface.

10. The antenna mast according to claim 1, wherein the device comprises a compartment with a door and a lock for locking the door, the lock configured to receive control data via the wireless communication system and the communication interface.

11. The antenna mast according to claim 1, wherein the device comprises a life-saving device configured to receive control data via the wireless communication system and the communication interface.

12. The antenna mast according to claim 1, wherein the device comprises a waste bin configured to communicate a status of filling of the waste bin via the communication interface and the wireless communication system.

13. The antenna mast according to claim 1, wherein the device comprises a weather station configured to send weather-related data via the communication interface and the wireless communication system.

14. The antenna mast according to claim 1, wherein the device comprises a vending machine configured to communicate a status of the vending machine via the communication interface and the wireless communication system.

15. The antenna mast according to claim 1, wherein the device comprises an electronic screen configured to receive data comprising information to be presented on the screen via the wireless communication system and the communication interface.

16. The antenna mast according to claim 1, wherein the device comprises a parking meter configured to communicate data relating to at least one of the parking meter and car parking facilities via the communication interface and the wireless communication system.

17. The antenna mast according to claim 1, wherein the device comprises an electric power socket configured to communicate data relating to use of the electric power socket via the communication interface and the wireless communication system.

18. A method implemented in an antenna mast of a wireless communication system for performing a function other than physically or functionally supporting an antenna arrangement at an elevated position on the antenna mast, wherein the mast body houses a transceiver arrangement and a processor of the wireless communication system, and also houses at least part of a device configured to perform said function, wherein the method comprises:
performing user-related communication operations in a cell of the wireless communication system, the cell comprising the antenna arrangement, the transceiver arrangement, and the processor,
establishing a communication link between the device and a third apparatus via a communication network, and
transferring data between the device and the third apparatus via the communication link.

19. The method according to claim 18, wherein establishing a communication link comprises:
establishing a connection between the device and at least one of the transceiver arrangement and the processor, and
establishing a connection between the transceiver arrangement and the third apparatus.

20. The method according to claim 19, wherein the connection between the device and at least one of the transceiver arrangement and the processor is established via a cable connection.

21. The method according to claim 19, wherein the connection between the device and at least one of the transceiver arrangement and the processor is established via a wireless connection.

22. The method according to claim 18, wherein transferring data comprises transferring data relating to at least one of:
a status of the device; and
a status of a service provided in connection with the device.

23. The method according to claim 18, wherein the device comprises an input device, and wherein transferring data comprises transferring data related to input signals received from the input device.

24. The method according to claim 18, wherein the device comprises an electronic screen, and wherein transferring data comprises transferring data comprising information to be presented on the electronic screen.

25. The method according to claim 18, wherein the third apparatus is a mobile communication device.
